(19) United States
(12) Patent Application Publication
(10) Pub. No.: US 2016/0021187 A1
(43) Pub. Date: Jan. 21, 2016

(54) VIRTUAL SHARED STORAGE DEVICE

(71) Applicants: Lizhi YING, (US); Xuefeng SONG, (US); EMPIRE TECHNOLOGY DEVELOPMENT LLC, Wilmington, DE (US)

(72) Inventors: Lizhi YING, Beijing (CN); Xuefeng SONG, Hebei (CN)

(73) Assignee: Empire Technology Development LLC, Wilmington, DE (US)

(21) Appl. No.: 14/765,395

(22) PCT Filed: Aug. 20, 2013
(86) PCT No.: PCT/CN2013/081814

§ 371 Date: Aug. 3, 2015

(51) Int. Cl. H04L 29/08; G06F 12/08

(52) U.S. Cl. CPC H04L 67/1097; G06F 12/0875; H04L 67/2842; G06F 2212/154

(57) ABSTRACT

In a cluster computing environment, multiple computing devices may be configured to share same storage devices to perform different portions of one or more computing tasks. The storage devices may be communicatively coupled to the computing devices via a network so that each of the multiple computing devices may retrieve data from or write data to the shard storage devices.

### TECHNICAL FIELD

The technologies described herein pertain generally to a virtual shared storage device in a cluster computing environment.

### BACKGROUND

Unless otherwise indicated herein, the approaches described in this section are not prior art to the claims in this application and are not admitted to be prior art by inclusion in this section.

In a cluster computing environment, multiple computing devices may be configured to share computing resources to perform different portions of one or more computing tasks. The shared computing resources may be located on the same physical platform of the respective computing devices or, alternatively, the computing resources may be communicatively coupled to the computing devices via a network.

### SUMMARY

Technologies are generally described for virtual shared storage device. The various techniques may be implemented in various devices, methods and/or systems.

In some examples, various embodiments may be implemented as devices. Some devices may include one or more external network interfaces configured to communicatively couple a memory storage device to one or more computing devices in a clustered computing environment, one or more memory units configured to store data received from one or more of the computing devices received via the one or more external network interfaces, and a management controller configured to manage one or more data transmission operations between the one or more computing devices and respective ones of the one or more memory units via the one or more external network interfaces.

In some examples, various embodiments may be implemented as systems. Some systems may include one or more computing devices, each of which includes a primary storage interfaced with a central processing unit (CPU) cache and a secondary storage; and a memory storage device communicatively coupled to the one or more computing devices via a network, wherein the memory storage device includes one or more external network interfaces configured to communicatively couple the memory storage device to one or more computing devices in a clustered computing environment, one or more memory units configured to store data received from one or more of the computing devices received via the one or more external network interfaces, and a management controller configured to manage one or more data transmission operations between the one or more computing devices and respective ones of the one or more memory units via the one or more external network interfaces.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items. In the drawings:

FIG. 1 shows an example system in which a virtual shared storage device may be implemented, arranged in accordance with at least some embodiments described herein;

FIG. 2 shows an example storage architecture in which a virtual shared storage device may be implemented, arranged in accordance with at least some embodiments described herein;

FIG. 3 shows an example storage device in which a virtual shared storage device may be implemented, arranged in accordance with at least some embodiments described herein; and

FIG. 4 shows a block diagram illustrating an example computing device that is arranged for a virtual shared storage device, arranged in accordance with at least some embodiments described herein.

### DETAILED DESCRIPTION

In the following detailed description, references are made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

In a cluster computing environment, multiple computing devices may be configured to share computing resources to perform different portions of one or more computing tasks. The computing resources may be communicatively coupled to the computing devices via a network. In some embodiments, memory storage devices may be configured to integrate network interfaces so that the multiple computing devices may access the memory storage devices via a network.

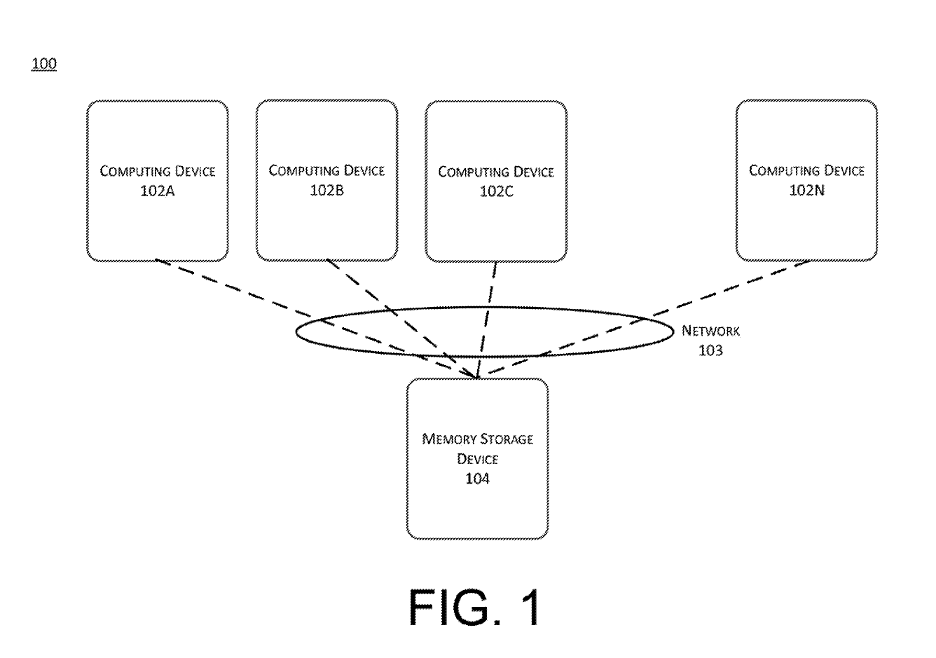

FIG. 1 shows an example system 100 in which a virtual shared storage device may be implemented. As depicted, example system 100 may include at least one or more computing devices 102A-102N, a network 103, and a memory storage device 104.

Computing devices 102A-102N may refer to one or more client devices that may be communicatively coupled to memory storage device 104. Computing devices 102A-102N may include one or more hardware components including, but not limited to, Central Processing Units (CPUs), memory devices, network ports, etc. The memory devices may further include registers, CPU caches, primary storages, secondary storages, etc. Unless context requires specific reference to one or more of computing devices 102A-102N, collective reference may be made to “computing devices” 102 as used herein.

Network 103 may refer to one or more communication links, which follow at least one of various communication protocols, by or through which computing device 102 may be communicatively coupled. The various communication protocols may include any mobile communications technology, e.g., GSM, CDMA, etc., depending upon the technologies supported by particular wireless service providers. The one or more communication links may be implemented utilizing non-cellular technologies such as conventional analog AM or FM radio, Wi-Fi™, wireless local area network (WLAN or IEEE 802.11), WiMAX™ (Worldwide Interoperability for Microwave Access), Bluetooth™, hard-wired connections, e.g., cable, phone lines, and other analog and digital wireless voice and data transmission technologies.

Memory storage device 104 may refer to a storage device that may be configured to include one or more memory units and at least one network interface. Thus, the one or more memory units may respond to one or more requests to access the memory units from computing device 102, via network 103. Memory storage device 104 may further include one or more controllers to manage reading or writing operations towards the one or more memory units.

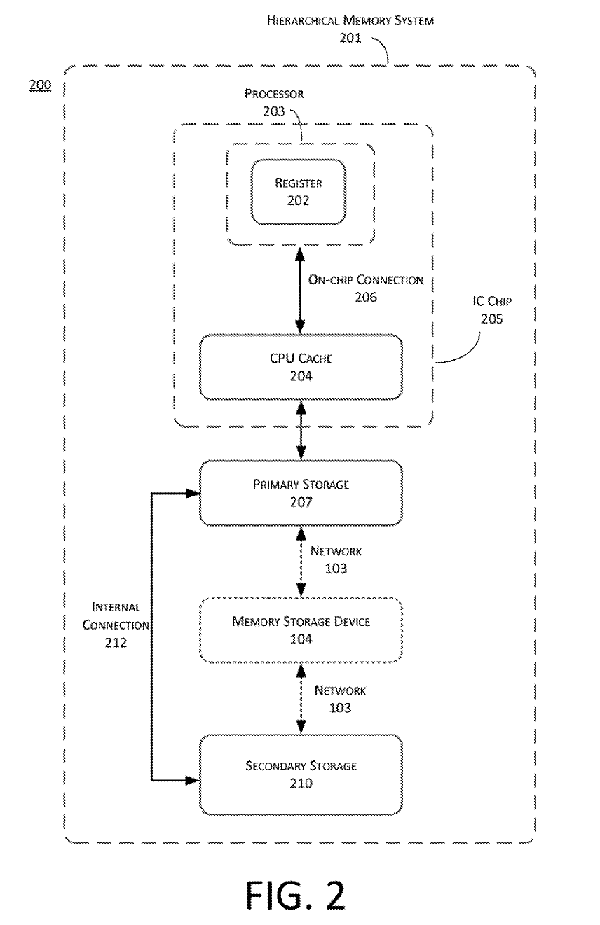

FIG. 2 shows an example storage architecture 200 in which virtual shared storage device may be implemented. As depicted, example storage architecture 200 may be implemented as a hierarchical memory system 201 that may include at least a register 202 of a processor 203, a CPU cache 204 that may be disposed on or in an integrated circuit (IC) chip 205, a primary storage 207, and a secondary storage 210. Primary storage 207 may be communicatively coupled to secondary storage 210 via an internal connection 212. Alternatively, primary storage 207 and secondary storage 210 may be configured to interface with memory storage device 104 via network 103.

Hierarchical memory system 201 may refer to a memory structure of a computing system, which may include multiple storage units with different parameters correspondingly disposed at different levels thereof. Such parameters may include response time, capacity, and/or controlling methods for the respective storage units. In accordance with some examples, memory units disposed at a higher level may be of less capacity but faster response time than other memory units at a lower level.

Register 202 may refer to a storage unit integrated as part of processor 203, which may be configured to store data loaded from a larger memory, e.g., CPU cache 204. Typically, register 202 may be at the highest level of a hierarchical memory system 201, and therefore may provide the highest read/write speed to the stored data, i.e., lowest response time, relative to other storage units at other levels in hierarchical memory system 201. Data stored in register 202 may be directly accessible by processor 203 and may be manipulated, or tested, by machine instructions received directly from processor 203. The manipulated data may be stored back in the larger memory, e.g., CPU cache 204 or primary storage 207.

Processor 203 may refer to a hardware component that may be configured to carry out the computer software programs. That is, processor 203 may be configured to first load data from CPU cache 204 into register 202 and, further, to process the loaded data in response to the instructions of the computer software programs.

CPU cache 204 may refer to a memory unit that may be attached to or proximately disposed relative to processor 203, which may be configured to feed data to processor 203 faster than primary storage 207 and secondary storage 210 but slower and less efficiently than accessing register 202. In accordance with some examples, unlike register 202, which may be configured to store data directly accessible to processor 203, CPU cache 204 may be configured to store the repeatedly and frequently accessed data to improve the overall performance of the respective one of computing devices 102. Since register 202 and CPU cache 204 may be packaged with processor 203 in IC chip 205, data may be loaded from and written to CPU cache 204 via an on-chip connection 206 built within IC chip 205.

On-chip connection 206 may refer to a connection between multiple components packaged in an IC chip, e.g., IC chip 205. In accordance with some embodiments, multiple IC components, e.g., processors and registers, may be packaged into a same flat pack in plastic or ceramic. On-chip connection 206 may then provide communication between the different multiple IC components so that the IC components may cooperate to carry out the instructions from the computer software programs.

Primary storage 207 may refer to one or more physical memory units, e.g., random access memory (RAM), that may be configured to store data that may be accessed in random order. That is, the order to access the stored data may not depend upon the order that the data were stored. Stored data may be accessed in any order regardless when or in what order the data were stored. Primary storage 207 may be configured to store portions of executable contents, e.g., software programs, or portions of buffering files, e.g., audio data in stream, for applications to be executed on one or more of computing device 102.

Secondary storage 210 may refer to one or more physical storage units, e.g., hard disks, CD-ROMs, USB flash drives, etc., that may be configured to store large amounts of data that are not directly accessible by the CPU. In accordance with some examples, computing devices 102 may load portions of the large amount of data from secondary storage 210 to primary storage 207 via internal connection 212. Internal connection 212 may refer to input/output channels, e.g., interface bus, of the respective one of computing devices 102.

In accordance with other examples, computing device 102 may load the portions of data from secondary storage 210 to memory storage device 104 via network 103. For example, in starting operating systems, files stored on local hard disks may be loaded to primary storage 207. Alternatively, files stored on local hard disks may be first loaded to memory storage device 104 for further use. Further, computing device 102 may retrieve portions of executable contents and/or portions of buffering files from memory storage device 104 via network 103 and store the portions of executable contents and/or portions of buffering files in primary storage 207.

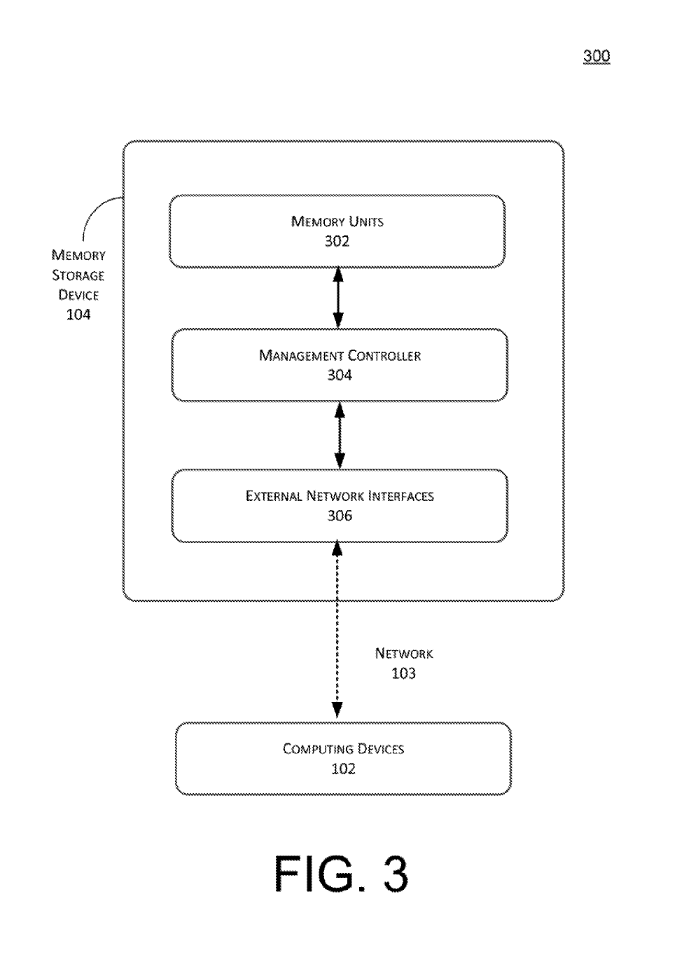

FIG. 3 shows an example storage device 104 in which a virtual shared storage device may be implemented. As depicted, memory storage device 104 may at least include one or more memory units 302, management controller 304, and one or more external network interfaces 306.

Memory units 302 may refer to one or more storage units that may be configured to store portions of the large amount of data that may be originally stored in secondary storage 210. Memory units 302 may be implemented in the form of RAM, hard disks, CD-ROMS, USB flash drives, etc.

Management controller 304 may refer to a software component, a hardware component, a firmware component, or a combination thereof, that may be configured to read data from or write data to memory units 302 in response to instructions from computing devices 102, received via external network interfaces 306.

External network interfaces 306 may refer to one or more hardware components that may be configured to communicatively couple memory storage device 104 to one or more corresponding external networks, e.g., network 103, to receive instructions, data, or other information, from one or more of computing devices 102.

In accordance with some examples, one or more of computing devices 102 may transmit instructions to memory storage device 104 to read portions of stored data from secondary storage 210. For example, when one of computing devices 102 is configured to execute a software program, loading of some portions of the software program may be delayed or otherwise forsaken at a particular time in order to save storage space, e.g., RAM of the corresponding one of computing devices 102. Accordingly, the one of computing devices 102 may instruct memory storage device 104 to load just those portions of the stored data that are required to execute the software program at the particular time. The instructions may be transferred from the one or more computing devices 102 to memory storage device 104 over network 103, via external network interfaces 306, and received by management controller 304. Management controller 304 may then load the portions of stored data corresponding to the instructions, e.g., pages or sections of software programs, from secondary storage 210, and store the loaded portions of data in memory units 302. The portions of data may be further transferred to primary storage 207 for processor 203 in response to multiple instructions from one or more computer software programs.

In accordance with other examples, computing device 102 may transmit instructions to memory storage device 104 to receive portions of data that include portions of executable contents and/or portions of buffering files from primary device 206. Management controller 304 may then read the portions of data from primary storage 207 and store the portions of data in memory units 302. The portions of data may be further transferred to secondary storage 210.

In some examples, the portions of data stored in memory storage device 104 may be shared with more than one computing devices. Management controller 304 may be configured to set a read/write status for each of the portions of data. For example, some portions of data may be read-only to one or more of computing devices 102 but modifiable to other ones of computing devices 102.

Thus, FIG. 3 shows an example storage device 104 that may include memory units 302, management controller 304, and external network interfaces 306.

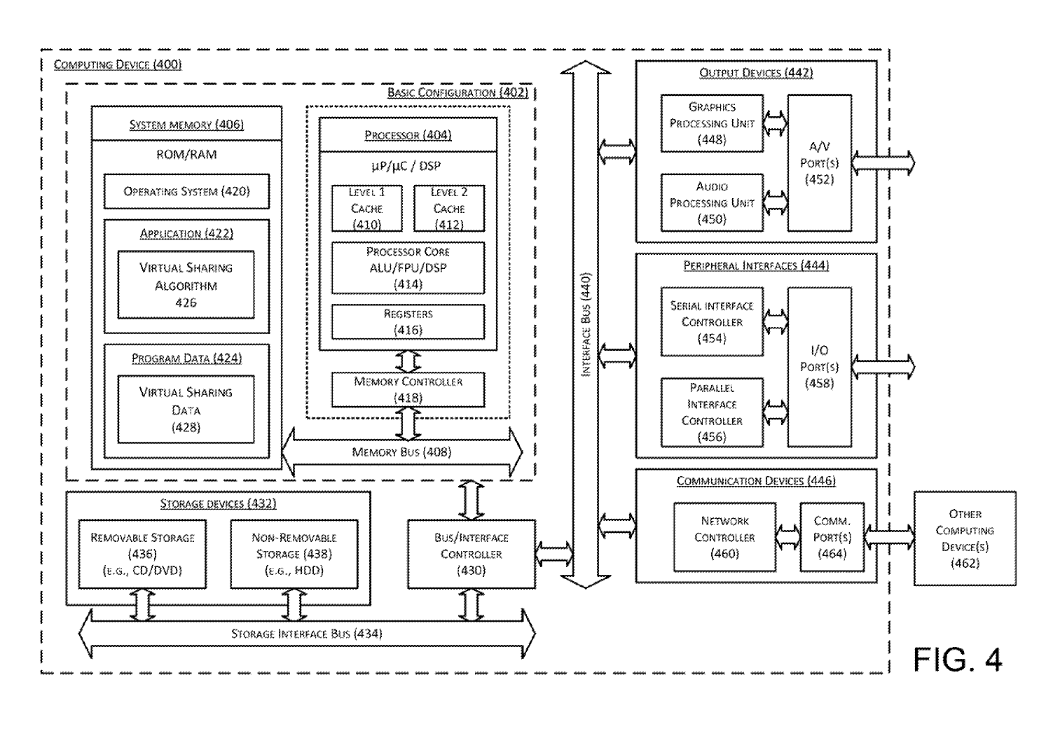

FIG. 4 is a block diagram illustrating an example computing device 400 that is arranged for virtual shared storage device in accordance with the present disclosure. In a very basic configuration 402, computing device 400 typically includes one or more processors 404 and a system memory 406. A memory bus 408 may be used for communicating between processor 404 and system memory 406.

Depending on the desired configuration, processor 404 may be of any type including but not limited to a microprocessor (μP), a microcontroller (μC), a digital signal processor (DSP), or any combination thereof. Processor 404 may include one more levels of caching, such as a level one cache 410 and a level two cache 412, a processor core 414, and registers 416. An example processor core 414 may include an arithmetic logic unit (ALU), a floating point unit (FPU), a digital signal processing core (DSP Core), or any combination thereof. An example memory controller 418 may also be used with processor 404, or in some implementations memory controller 418 may be an internal part of processor 404.

Depending on the desired configuration, system memory 406 may be of any type including but not limited to volatile memory (such as RAM), non-volatile memory (such as ROM, flash memory, etc.) or any combination thereof. System memory 406 may include an operating system 420, one or more applications 422, and program data 424. Application 422 may include a virtual sharing algorithm 426 that is arranged to access memory storage device 104 to load or save data thereto. Program data 424 may include virtual sharing data 428 that may be useful for operation with virtual sharing algorithm 426 as is described herein. In some embodiments, application 422 may be arranged to operate with program data 424 on operating system 420 such that implementations of virtual shared storage device may be provided as described herein. This described basic configuration 402 is illustrated in FIG. 4 by those components within the inner dashed line.

Computing device 400 may have additional features or functionality, and additional interfaces to facilitate communications between basic configuration 402 and any required devices and interfaces. For example, a bus/interface controller 430 may be used to facilitate communications between basic configuration 402 and one or more data storage devices 432 via a storage interface bus 434. Data storage devices 432 may be removable storage devices 436, non-removable storage devices 438, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 406, removable storage devices 436 and non-removable storage devices 438 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 400. Any such computer storage media may be part of computing device 400.

Computing device 400 may also include an interface bus 440 for facilitating communication from various interface devices (e.g., output devices 442, peripheral interfaces 444, and communication devices 446) to basic configuration 402 via bus/interface controller 430. Example output devices 442 include a graphics processing unit 448 and an audio processing unit 450, which may be configured to communicate to various external devices such as a display or speakers via one or more A/V ports 452. Example peripheral interfaces 444 include a serial interface controller 454 or a parallel interface controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. An example communication device 446 includes a network controller 460, which may be arranged to facilitate communications with one or more other computing devices 462 over a network communication link via one or more communication ports 464.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 400 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 400 may also be implemented as a personal computer including both laptop computer and non-laptop computer configurations.

In an illustrative embodiment, any of the operations, processes, etc. described herein can be implemented as computer-readable instructions stored on a computer-readable medium. The computer-readable instructions can be executed by a processor of a mobile unit, a network element, and/or any other computing device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A memory storage device, comprising:
one or more external network interfaces configured to communicatively couple the memory storage device to one or more computing devices in a clustered computing environment;
one or more memory units configured to store data received from one or more of the computing devices received via the one or more external network interfaces; and
a management controller configured to manage one or more data transmission operations between the one or more computing devices and respective ones of the one or more memory units via the one or more external network interfaces.

2. The memory storage device of claim 1, further comprising one or more memory interfaces configured to receive one or more additional memory units.

3. The memory storage device of claim 1, wherein the one or more memory units includes random access memory (RAM), dynamic random access memory (DRAM), and static random access memory (SRAM).

4. The memory storage device of claim 1, wherein the management controller is configured to transfer data directly between the one or more external network interfaces and the one or more memory units.

5. The memory storage device of claim 1, wherein the management controller is configured to transfer data between the one or more external network interfaces and the one or more memory units via one or more buffers.

6. The memory storage device of claim 1, wherein each of the one or more computing devices includes:
a primary storage interfaced with a central processing unit (CPU) cache; and
a secondary storage.

7. The memory storage device of claim 6, wherein the management controller is further configured to manage the one or more data transmission operations between the one or more external network interfaces and the primary storage of respective ones of the one or more computing devices.

8. The memory storage device of claim 6, wherein the management controller is further configured to manage the one or more data transmission operations between the one or more external network interfaces and the second storage of respective ones of the one or more computing devices.

9. The memory storage device of claim 6, wherein the one or more computing devices are configured to read one or more portions of a program installed on the one or more memory units to the primary storage.

10. The memory storage device of claim 6, wherein the one or more computing devices are configured to set at least one or more portions of the data stored on the one or more memory units as read-only, write-only, or shareable to others of the one or more computing device.

11. A clustered computing system, comprising:
one or more computing devices, each of which includes a primary storage interfaced with a central processing unit (CPU) cache and a secondary storage; and
a memory storage device communicatively coupled to the one or more computing devices via a network, wherein the memory storage device includes:
one or more external network interfaces configured to communicatively couple the memory storage device to one or more computing devices in a clustered computing environment,
one or more memory units configured to store data received from one or more of the computing devices received via the one or more external network interfaces, and
a management controller configured to manage one or more data transmission operations between the one or more computing devices and respective ones of the one or more memory units via the one or more external network interfaces.

12. The clustered computing system of claim 11, wherein the memory storage device further comprises one or more memory interfaces configured to receive one or more additional memory units.

13. The clustered computing system of claim 11, wherein the one or more memory units includes random access memory (RAM), dynamic random access memory (DRAM), and static random access memory (SRAM).

14. The clustered computing system of claim 11, wherein the management controller is configured to transfer data directly between the one or more external network interfaces and the one or more memory units.

15. The clustered computing system of claim 11, wherein the management controller is configured to transfer data between the one or more external network interfaces and the one or more memory units via one or more buffers.

16. The clustered computing system of claim 11, wherein management controller is further configured to manage the one or more data transmission operations between the one or more external network interfaces and the primary storage of respective ones of the one or more computing devices.

17. The clustered computing system of claim 11, wherein management controller is further configured to manage the one or more data transmission operations between the one or more external network interfaces and the secondary storage of respective ones of the one or more computing devices.

18. The memory storage device of claim 11, wherein the one or more computing devices are configured to read one or more portions of a program installed on the one or more memory units to the primary storage.

19. The memory storage device of claim 11, wherein the one or more computing devices are configured to set at least one or more portions of the data stored on the one or more memory units as read-only, write-only, or shareable to others of the one or more computing device.
